(19) United States
(12) Patent Application Publication
(10) Pub. No.: US 2013/0122120 A1
(43) Pub. Date: May 16, 2013

(54) INSECTICIDAL COMPOSITIONS AND METHODS

(71) Applicant: Emira Angjeli, Woodside, NY (US)

(72) Inventor: Emira Angjeli, Woodside, NY (US)

(21) Appl. No.: 13/676,297

(22) Filed: Nov. 14, 2012

Related U.S. Application Data
(60) Provisional application No. 61/629,156, filed on Nov. 14, 2011.

(51) Int. Cl. A01N 41/02; A01N 65/08; A01N 65/44

(52) U.S. Cl. CPC A01N 41/02; A01N 65/44; A01N 65/08
USPC 424/725; 514/553; 514/784; 514/772

(57) ABSTRACT

The present invention provides compositions that may be an aqueous insecticide containing at least one surfactant, such as for instance, sodium lauryl sulfate, at least one preservative, such as for instance, a potassium salt or sodium chloride, a nutrient source, such as for instance a yeast, an organic acid capable of lowering the pH of the aqueous insecticide, such as for instance citric acid, a fragrance, such as for instance geranium oil, and water. The aqueous insecticide may be designed to more efficiently kill and thereby control populations of species of Cimex, such as, for instance, Cimex lectularius.

### FIELD OF THE INVENTION

The invention relates to insecticidal compositions and methods for using the same to control such insects as those of the genus Cimex, for example, Cimex lectularius.

### BACKGROUND OF THE INVENTION

Cimex lectularius, commonly known as the “bedbug,” infestations have increased dramatically in recent years. Therefore, insecticides able to specifically control bed bug infestations are needed, especially those that are not only effective in eliminating insect colonies but are also safe and environmentally friendly. Some commercially available products contain highly toxic ingredients that are harmful to both targeted insects and users. Some commercial insecticides despite reported efficacy may pose certain health risks and present unwelcomed side effects. Also, these commercially available insecticides may be harmful to the environment. Similarly, they pose problems relating to their use and disposal. As a result, there is increased consumer demand for insecticides that are less toxic and present fewer side effects.

Few products have been reported to successfully provide these features. Products having less toxicity are typically of limited efficacy particularly for bed bug infestations. U.S. Pat. No. 6,548,085 teaches using “non-poisonous” chemicals, primarily for various species of cockroaches, ants, and soft-bodied flying insects such as mosquitoes. U.S. Pat. No. 6,231,865 teaches combining citrus oils and garlic oils for use in an agricultural setting to protect certain plants from various forms of fungi and bacteria. U.S. Pat. No. 6,103,763 teaches that sodium lauryl sulfate offers some limited efficacy for treating aphids, killing the nymphs, but merely delays death in adults.

Some natural insecticides that use surfactants. However, the surfactant content of these products is generally relatively high, and these products generally have limited efficacy against hard bodied insects, being useful generally for insects with soft-bodies, e.g. mosquitoes.

Sodium dodecyl sulfate (SDS or NaDS), sodium lauryl sulfate or sodium lauryl sulfate (SLS) is an organic compound with the formula CH₃(CH₂)₁₁OSO₃Na). It is an anionic surfactant used in many cleaning and hygiene products. The salt is of an organosulfate consisting of a 12-carbon tail attached to a sulfate group, giving the material the amphiphilic properties required of a detergent. Being derived from inexpensive coconut and palm oils, it is a common component of many domestic cleaning products.

SDS is mainly used in detergents for laundry and many cleaning applications. SDS is a highly effective surfactant and is used in any task requiring the removal of oily stains and residues. For example, it is found in higher concentrations with industrial products including engine degreasers, floor cleaners, and car wash soaps. It is found in toothpastes, shampoos, shaving foams, and bubble bath formulations in part for its thickening effect and its ability to create a lather.

It can be used to aid in lysing cells during DNA extraction and for unraveling proteins in SDS-PAGE. Sodium lauryl sulfate, in science referred to as sodium dodecyl sulfate (SDS) or Duponol, is commonly used in preparing proteins for electrophoresis in the SDS-PAGE technique. This compound works by disrupting non-covalent bonds in the proteins, denaturing them, and causing the molecules to lose their native shape (conformation).

This new negative charge is significantly greater than the original charge of that protein. The electrostatic repulsion that is created by binding of SDS causes proteins to unfold into a rod-like shape thereby eliminating differences in shape as a factor for separation in the gel. Sodium lauryl sulfate is probably the most researched anionic surfactant compound. Like all detergent surfactants (including soaps), sodium lauryl sulfate removes oils from the skin, and can cause skin and eye irritation. The critical micelle concentration (CMC) in pure water at 25° C. is 0.0082 M, and the aggregation number at this concentration is usually considered to be about 62. The micelle ionization fraction (a) is around 0.3 (or 30%). Aqueous solutions of SDS are also popular for dispersing (or suspending) nanotubes.

SDS represent a potentially effective topical microbicide, which can also inhibit and possibly prevent infection by various enveloped and non-enveloped viruses such as the Herpes simplex viruses, HIV, and the Semliki Forest Virus. In medicine, sodium lauryl sulfate is used rectally as a laxative in enemas, and as an excipient on some dissolvable aspirins and other fiber therapy caplets. SDS is not carcinogenic when either applied directly to skin or consumed. A review of the scientific literature stated “SLS [SDS] was negative in an Ames (bacterial mutation) test, a gene mutation and sister chromatid exchange test in mammalian cells, as well as in an in vivo micronucleus assay in mice. The negative results from in vitro and in vivo studies indicate SDS does not interact with DNA.” It has been shown to irritate the skin of the face with prolonged and constant exposure (more than an hour) in young adults. SDS may worsen skin problems in individuals with chronic skin hypersensitivity, with some people being affected more than others. In animal studies SDS appears to cause skin and eye irritation.

Pelargonium graveolens is a species in the Pelargonium genus, often called geranium. This specific species has great importance in the perfume industry. It is cultivated on a large scale and its foliage is distilled for its scent. P. graveolens cultivars have a wide variety of smells, including rose, citrus, mint, coconut and nutmeg, as well as various fruits. However, the most commercially important varieties are those that have rose scents.

Pelargonium distillates and absolutes, commonly known as “geranium oil,” are sold for aromatherapy and massage therapy applications is sometimes used to supplement or adulterate more expensive rose oils. Other applications include use as a natural insect repellent.

### SUMMARY OF THE INVENTION

The compositions and formulations described herein provide a safe, environmentally friendly, effective insecticide that is particularly useful for controlling and eradicating infestations of species of Cimex such as Cimex lectularius, the common bedbug.

In one aspect, the present invention provides a composition that may be an aqueous insecticide containing at least one surfactant, a preservative, such as for instance, a potassium salt or sodium chloride in proportions similar to those normally detected in mammalian blood, a nutrient source, an organic acid capable of lowering the pH of the aqueous insecticide, a fragrance, and water. The aqueous insecticide may be designed to more efficiently control species of Cimex, such as, for instance, Cimex lectularius, that have a hard outer exoskeleton that is protective against some conventional insecticides. The composition that may be an aqueous composition may contain one or more of the following: a) a surfactant in an amount sufficient to operate as an solubilizing agent; b) a preservative, for instance a potassium salt, in an amount sufficient to prevent growth of microorganisms resulting from the presence of the surfactant; c) sodium chloride or one or more other compounds present in mammalian blood, at a concentration that may be similar to that found in mammalian blood; d) a nutrient source that may attract insects; e) an organic acid that may lower the pH of the aqueous insecticide; and f) water.

In some instances, some components and ingredients of the composition may operate to disrupt or compromise the waxy exoskeleton of an insect. In some instances, due to the presence of one or more nutrients and salts, the insect may consume some of the composition. This may allow the surfactant to disrupt gastric surfaces of the insect. Further, some components and ingredients of the composition may also disrupt pores and more vulnerable areas between the plates of the insects' exoskeleton. Hence, the compositions described herein may be effective though having lower surfactant concentrations than in other insecticides that are used effectively for soft-bodied insects such as, for instance, mosquitoes.

In a second aspect, the present invention provides a container containing a composition as described herein. The container may be adapted for spraying the composition. The container may be, for example, a spray bottle. Further, the present invention provides a gel composition comprising a gelling agent in combination with any of the compositions described herein.

In a third aspect, the present invention provides methods for killing insects or controlling insect populations featuring applying a composition as described herein to an area of insect infestation. The insect may be a hard-bodied insect such as a species of the genus Cimex, e.g. Cimex lectularius. The applying may be performed by, for instance, dusting, spraying, sprinkling, or pouring the composition. The method may feature applying the composition once, twice, three times, five times, ten times or more, or repeatedly, such as, for instance on consecutive days, for at least two, three, four, five or more consecutive days, or repeating the application once, twice, three times, four times, five times, six times or more a week for at least about one month, two months, three months, four months or more. In some instances, the composition insecticide kills or controls the population of adults, larvae and eggs.

### DETAILED DESCRIPTION OF THE INVENTION

The examples and specific embodiments described herein are merely exemplary and are not intended as limiting the invention or the scope of the claims.

In one aspect the present invention provides a composition that may be an aqueous composition containing the following:

a) a surfactant in an amount sufficient to operate as an solubilizing agent;
b) a preservative, for instance a potassium salt, in an amount sufficient to prevent growth of microorganisms resulting from the presence of the surfactant;
c) a nutrient source that may attract insects;
d) an organic acid; and
e) water.
The composition may optionally also contain a sodium chloride or one or more other compounds present in mammalian blood, at a concentration similar to that found in mammalian blood.

The surfactant may be anionic surfactant having a high water solubility, such as, for instance, sodium lauryl sulfate, and it may be present in an amount of, for instance, 1-10% by weight, 2-9%, 3.5-8.0%, 3.5-4.0%, 3.75-4.25%, or about 3.9%, 4% or 4.1% relative to the weight of the composition. The preservative may be sorbic acid and/or a salt of sorbic acid such as, for instance, sodium sorbate, potassium sorbate, and/or calcium sorbate, or a mixture thereof, and the preservative may be present in an amount of about 0.05% to about 2%, about 0.1% to about 1%, e.g., 0.1- 0.5%, 0.2-0.4%, 0.25-0.35%, or about 0.25% or 0.27% relative to the weight of the aqueous insecticide. The nutrient source may be a simple carbohydrate such as a simple carbohydrate produced by a yeast contained within the aqueous insecticide. The organic acid that may be capable of lowering the pH of the aqueous insecticide may be acetic acid. The final pH of the aqueous insecticide may be less than about 7, for instance about 3-6.75 or about 4-6.5. The water may be distilled water.

The composition may also contain a fragrance such as, for instance, an essential oil. The fragrance may be, for instance, lemongrass oil or geranium oil. The fragrance may be present in an amount of approximately 0.01-2.0%, .05-1.0%, about 0.15-0.9%, about 0.3-0.8%, about 0.4-0.6% or about 0.5% by weight relative to final weight of aqueous insecticide.

In one embodiment, the composition contains about 4.00% by weight sodium lauryl sulfate, about 1.12% sodium chloride, about 0.27% potassium sorbate, yeast, citric acid, geranium oil 0.50%, ethyl lactate and distilled water. In some embodiments, the composition lacks any effective amounts of any additional insecticide. In some embodiments the composition is an aqueous insecticide. In some instances, the composition may be diluted with water in a volume/volume ratio of, e.g., 1:1, 1:2, 1:2.5; 1:3; 1:3.5, 1:4, 1:4.5, 1:5. 1:6, 1:7, 1:10, or 1:100.

The composition may incorporate one or more surfactant such as those known in the art. Exemplary surfactants include those that are relatively stable over a wide pH range, for example, anionic, cationic, nonionic or zwitterionic surfactants. In some embodiments, anionic surfactants may include the water soluble salts of alkyl sulfates having from about 10 to about 18 carbon atoms in the alkyl radical and the water soluble salts of sulfonated monoglycerides of fatty acids having about 10 to about 18 carbon atoms. Sodium lauryl sulfate, sodium lauryl sarcosinate and sodium coconut monoglyceride sulfonates are such anionic surfactants. Mixtures of such anionic surfactants may also be used.

The composition may use any one or a combination of organic acids. Exemplary organic acids include, for instance, malic acid, fumaric acid, tartaric acid, lactic acid, citric acid, and acetic acid. The organic acid may be added to the compositions of the present invention as a mixture of materials, such as present in vinegar when acetic acid is selected as the organic acid. Various types of vinegars may be used, such as, for instance, food grade vinegars. The vinegars may also have colors or dyes, for example, red wine vinegar, apple cider vinegar, and balsamic vinegar. A number of particular vinegars are suitable as long as the required amount of acetic acid is present in the final composition.

The amount of sodium chloride normally detected in mammalian blood is well known to those of skill in the art. For example the amount of sodium chloride present is isotonic with mammalian blood. In addition to sodium chloride, the compositions of the present invention may also contain other salts, ions and compounds also present in mammalian blood, e.g., human blood, such as lactate, potassium and calcium. Such may be provided with appropriate amounts of sodium lactate, calcium chloride, and potassium chloride. In one embodiment, the amount of salt in the composition produces a solution that is substantially isotonic with mammalian blood, e.g., human blood, for example, as present in normal saline, Lactated Ringer's solution. Thus, the compositions of the present invention may comprise one or more of the following ions:

sodium ion at approximately 100 to 150 or 130 mmol/L;
chloride ion at approximately 100 to 125 or 109mmol/L;
lactate ion at approximately 20 to 35 or 28 mmol/L;
potassium ion at approximately 1 to 10 or 4 mmol/L; and
calcium ion at approximately 1 to 2 or 1.5 mmol/L.

The nutrient source of the composition may be a simple carbohydrate. The simple carbohydrate may be a yeast or one or more compounds produced by a yeast. Other nutrient sources may include any one or a combination of casamino acids, trypton, and yeast extract.

The composition may also contain one or more additional ingredient, such as, for instance, a dye or color, and mammalian whole blood or blood components (such as plasma, red blood cells, hemoglobin, etc), such as from leporidae, canine, feline, bovine, porcine, murine, homo, and/or bovidae.

The composition may be prepared as a thixotropic fluid or gel. In one embodiment, the composition also comprises a gelling material, allowing for dispensing the insecticide composition as a solid gel, e.g., squeezed through a tube. Gel compositions are well known in the art, and may include hydrogels, organogels, or xerogels, all known by those of skill in the art. When the composition is in the form of a gel, the gel may be dispersed, e.g., along the base of a wall, around the perimeter of a bed, along or around the base of a bed, along or around a bed box spring, or along or around any other boundary where it is desirable to inhibit or retard an insect from crossing over.

The materials required for the compositions of the present invention may be obtained from any number of commercially available sources, such as Sigma Aldrich (St. Louis, Mo., US), Alpha Chem, Inc. (Lexington Mass., US), Fisher Scientific Company (Pittsburgh, Pa.), VWR International (West Chester, Pa., US), and Becton, Dickinson and Company (Franklin Lakes, N.J., US).

One particular advantage of the compositions described herein is that they provide the ability to attract and thereby localize insects such as bedbugs to a desired area using a nutrient source. Thus, once individual insects are substantially closer to one another physically or spatially, there is an increased likelihood that substantially all insects may be contacted with the composition. Such an advantage reduces the chance of recurrent infestation. Another advantage of the compositions described herein is that they do not release dangerous, noxious or toxic fumes. Therefore, the methods described herein may be practiced without the need to provide additional ventilation to the immediate area or room where the compositions are applied.

In a second aspect, the present invention provides a container containing a composition as described herein. The container may be adapted for spraying the composition such as, for example, a spray bottle. Further, the present invention provides a gel composition comprising a gelling agent in combination with any of the compositions described herein.

In a third aspect, the present invention provides methods for killing insects or controlling insect populations featuring applying a composition as described herein to an area of insect infestation. The insect may be a hard bodied insect such as a species of the genus Cimex, e.g. Cimex lectularius. The applying may be performed by, for instance, dusting, spraying, sprinkling, or pouring the composition. The method may feature applying the composition once, twice, three times, five times, ten times or more, or repeatedly, such as, for instance on consecutive days, for at least two, three, four or more consecutive days, or repeating the application once, twice, three times, four times or more a week for at least one month, two months, three months, four months or more. In some instances, the composition substantially kills or controls the population of adults, larvae and eggs. The methods may feature applying the composition repeatedly to objects used by either humans or pets. Examples of such objects include, for instance, beds and upholstered furniture. The methods may feature applying the composition to bedding, clothing, or luggage to reduce or prevent transfer of Cimex lectularius from an initially infested area to a subsequent area.

The methods described herein provide an added advantage that the area or object to which the composition, e.g. the aqueous insecticide, is applied may be used for its intended or normal use or function relatively quickly, for instance, even immediately. For instance, a composition as described herein may be applied to a bed, and the bed may be used a short time afterward.

The methods also feature and provide means to prevent, treat, reduce the incidence, or reduce the risk of cimicosis on a mammal such as, for instance a human, by applying a composition as described herein to the surface, skin or hair of the mammal.

The compositions of the present invention may be applied, e.g., dispensed or sprayed, onto surfaces or materials to be treated by any methods known in the art. In one embodiment, the composition may be provided in a bottle that may squirt, spray or mist fluids, for instance a spray bottle. In another embodiment, the compositions may be pressurized in a container to be delivered as an aerosol spray.

### DETAILED DESCRIPTION OF THE PREFERRED EMBODIMENTS

### EXAMPLE 1

A concentrated composition of the present invention is prepared as follows:

1. 19.2 oz of SLS is added to 2 gallons of water. The mixture is stirred and allowed to sit for at least 2 minutes, e.g., 10 minutes.
2. 1.7 oz of potassium sorbate is added to 1 gallon of water. The mixture is stirred and allowed to sit for at least 2 minutes, e.g., 10 minutes.
3. 7.1 oz of sodium chloride is added to 1 gallon of water. The mixture is stirred and allowed to sit for at least 2 minutes, e.g., 10 minutes.
4. The solutions of Step 1, 2, and 3 are mixed together.
5. 1 gallon of vinegar (5% acetic acid) is added to the mixture of Step 4.
6. 3.2 oz, or 6 to 8 oz of lemongrass oil is added to the solution of Step 5.
7. 2.5 oz of yeast is added to the solution of Step 6 and mix.

The water used to dissolve the ingredients may have a temperature less than 20,° room temperature (about 20° C. to about 25° C.), warm (about 25° C. to about 50° C., hot (about 50° C. to about 99° C.), or boiling water (about 100° C. or greater). If the water temperature is warm, hot or boiling, such solutions may be allowed to sit until the solution reaches room temperature. The composition may be allowed to sit for a period of time, e.g., 1 hour, 6 hours, at least 12 hours, at least 24 hours, at least 2 days, at least 1 week, at least one or six months, or at least one year prior to dilution with water.

### EXAMPLE 2

8 oz by volume of the composition of Example 1 is added to 24 oz water. The mixture is stirred. The compositions may be made in single batches or may be manufactured continuously, and batch sizes can be easily scaled up.

### EXAMPLE 3

The composition of Example 2 is dispensed in a spray-type bottle. Cimex lectularius are observed on normal sofa fabric. The composition of Example 3 is sprayed on to the Cimex lectularius at a distance of 12 inches, and will kill the insects. The death of the Cimex lectularius may be verified and observed when the insects are observed to remain “standing on their head.” Death may be observed within 1 to 30 seconds after application, within 20 seconds, or within 6 and 15 seconds.

### EXAMPLE 4

Cimex lectularius are observed on a wooden surface of a bed box spring. The composition of Example 2 is dispensed in a spray-type bottle and is applied to the Cimex lectularius. Death is observed within 3 to 6 seconds.

### EXAMPLE 5

Cimex lectularius is observed on a carpet or rug. The composition of Example 2 dispensed in a spray-type bottle is applied to the Cimex lectularius. Death is observed within 8 to 20 seconds.

### EXAMPLE 6

Cimex lectularius is observed on clothing, either poly-blend and/or cotton. The composition of Example 2 dispensed in a spray-type bottle is applied to the Cimex lectularius. Death is observed within 6 to 15 seconds.

### EXAMPLE 7

Cimex lectularius is observed on sheetrock. The composition of Example 2 dispensed in a spray-type bottle is applied to the Cimex lectularius. Death is observed within 3 to 6 seconds.

### EXAMPLE 8

Cimex lectularius is observed on bedding. The composition of Example 2 dispensed in a spray-type bottle is applied to the Cimex lectularius. Death is observed within 1 to 30 seconds.

### EXAMPLE 9

Approximately 4.1 grams of SLS, 0.27grams of potassium sorbate, 1 gram of sodium chloride, and 3 grams of yeast are mixed and packaged. The compositions of the package are added to approximately 100 g of water and mixed to yield an insecticide composition.

### EXAMPLE 10

One gallon of the composition of Example 1 is mixed in a container with 2 to 4 gallons, e.g., 3 gallons of water. Fabrics contaminated with Cimex lectularius are added to the container and are soaked for 1 hour, 12 hours, 1 day, or 2 days to treat the fabric in order to kill Cimex lectularius. Similarly, the composition of Example 1 is added to a laundry machine to wash fabrics.

### EXAMPLE 11

25 ounces of rice granulated sodium lauryl sulphate is mixed with two gallons of filtered water at 110° F. in a container such as a drum until completely dissolved. 3.2 ounces of a geranium oil is added to the mix. Then, 1 ounce of liquid citric acid is added. Add 2 gallons of 110° F. filtered water into a second container such as a drum. 1 ounce liquid citric acid and 1 teaspoon of ethyl lactate is then added. Mix the two containers together for about 10 minutes or until the product is completely blended. A composition of 4.00% SLS and 0.50% geranium oil, citric acid and ethyl lactate is produced.

What is claimed:

1. An aqueous insecticide composition comprising:
a) a surfactant;
b) a preservative;
c) a nutrient source;
d) an organic acid; and
e) water.

2. The composition according to claim 1 wherein the surfactant is an anionic surfactant.

3. The composition according to claim 1 wherein the surfactant is sodium lauryl sulfate.

4. The composition according to claim 1 wherein the surfactant is present in an amount of about 1-10% by weight.

5. The composition according to claim 1 wherein the surfactant is present in an amount of about 4% by weight.

6. The composition according to claim 1 wherein the preservative is potassium sorbate.

7. The composition according to claim 1 wherein the preservative is present in an amount of about 0.20% to about 0.30% by weight.

8. The composition according to claim 1 wherein the nutrient source comprises a yeast.

9. The composition according to claim 1 wherein the organic acid is citric acid.

10. The composition according to claim 1 having a final pH of less than 7.

11. The composition according to claim 1 further comprising a fragrance.

12. The composition according to claim 11 wherein the fragrance comprises an essential oil.

13. The composition according to claim 11 wherein the fragrance is geranium oil.

14. The composition according to claim 11 wherein the fragrance is present in an amount of about 0.05-1.0%.

15. The composition according to claim 11 wherein the fragrance is present in an amount of about 0.50%.

16. The composition according to claim 1 comprising about 4.00% sodium lauryl sulfate, about 0.50% geranium oil, citric acid, ethyl acetate, and distilled water.

17. A spray bottle containing a composition according to claim 1.

18. A method of killing species of Cimex comprising applying a composition according to claim 1.

19. The method of claim 18 wherein the species of Cimex is Cimex lectularius.

20. The method of claim 18 wherein the composition operates to kill adult Cimex lectularius, Cimex lectularius larvae, and Cimex lectularius eggs.
